(19) United States
(12) Patent Application Publication
(10) Pub. No.: US 2024/0284899 A1
(43) Pub. Date: Aug. 29, 2024

(54) WILD GAME TOTE AND TIMBER STRAP INCLUDING ADJUSTABLE RETAINING LOOPS

(71) Applicant: TAKEEM LLC, Pulaski, WI (US)

(72) Inventor: Bryan Urben, Pulaski, WI (US)

(73) Assignee: TAKEEM LLC, Pulaski, WI (US)

(21) Appl. No.: 18/586,713

(22) Filed: Feb. 26, 2024

Related U.S. Application Data
(60) Provisional application No. 63/487,119, filed on Feb. 27, 2023.

(51) Int. Cl. A01M 31/00

(52) U.S. Cl. CPC A01M 31/006

(57) ABSTRACT

A game tote for carrying small animals or birds. The game tote includes a series of game straps each designed to carry a single small animal or bird. The game straps are each formed from a wire section that include a braided cable or wire surrounded by a coating, such as vinyl or PVC. The outer end of each game strap includes a retaining loop that is formed by the end of the wire section. A slide block is located near the end of the wire section. The wire section passes through a sliding section of the slide block and the end of the wire section is secured in a crimping section. The wire section slides into and out of the sliding section to expand and contract the retaining loop. The outer coating on the wire section both protects the cable and restricts the sliding movement of the wire section.

### CROSS REFERENCE TO RELATED APPLICATIONS

The present application is based on and claims priority to U.S. Provisional Patent Application Ser. No. 63/487,119, the disclosure of which is incorporated herein by reference.

### BACKGROUND

The present disclosure generally relates to a wild game tote for carrying wild game, such as birds or small mammals. More specifically, the present disclosure relates to a wild game tote that includes adjustable retaining loops that can be secured to a leg or neck of the wild game such that multiple birds or animals can be carried by a hunter.

Presently, game totes are available that include a series of game straps that include some type of loop near the end of the game strap. The game straps extend from a connection point that allows the game tote to be attached to a belt or back pack of a hunter. However, most game totes are formed from a natural material, such as leather, which can become damaged or weakened over extended use, especially in wet environments. The leather game straps also become stretched out during use and the retaining loops on the ends of the game straps are difficult to adjust to compensate for different sized birds or small animal.

The inventor recognized the problems with the adjustability and durability of current game totes and developed the game tote of the present disclosure to address these problems.

### SUMMARY

The present disclosure relates to a wild game tote for carrying wild game, such as birds or small mammals. The wild game tote includes multiple wire sections that each include a retaining loop formed on each end. The retaining loop is adjustable by the movement of a slide block. One end of the wire section is crimped into the slide block such that it is fixed to the slide block. The wire section passes through a sliding portion of the slide block such that the size of the retaining loop can be adjusted. Friction holds the slide block in position along the wire section to retain the desired size of the retaining loop.

In an exemplary embodiment of the present disclosure, the game tote includes multiple wire sections that are each formed from a vinyl or PVC coated wire. However, other materials are contemplated as being within the scope of the present disclosure. In one contemplated embodiment, each wire section is secured to an attachment clip at a mid-point of the wire section. The attachment clip provided a convenient point of selective attachment of the wild game tote to the hunter. Each wire section includes a slide block attached to each of its two ends. The slide blocks on each end of the wire section create two separate retaining loops that can be independently adjusted.

In another contemplated embodiment, each of the wire sections is connected to the attachment ring at one end and includes the retaining loop on the opposite first end. The retaining loop includes the slide block that allows the size of the retaining loop to be adjusted by the hunter depending on the type of animal or bird killed by the hunter.

In another contemplated embodiment, a timber strap is provided in which one of the wire sections can be connected at each of its two ends to an attachment block that is designed for attachment to a firearm, such as a rifle or shotgun. The wire section creates a loop that can pass over an arm and shoulder of the hunter such that the timber strap allows the hunter to carry the firearm during climbing or other movement.

Various other features, objects and advantages of the invention will be made apparent from the following description taken together with the drawings.

### BRIEF DESCRIPTION OF THE DRAWINGS

The drawings illustrate the best mode presently contemplated of carrying out the disclosure. In the drawings:

FIG. 1 is a front view of a wild game tote that includes six retaining loops in accordance with the present disclosure;

FIG. 2 is a view of the three coated wire sections that each include two of the retaining loops;

FIG. 3 is a magnified view showing the coated wire sections secured to each other and to an attachment clip;

FIG. 4 is a view showing the retaining loops in three states of adjustment;

FIG. 5 is a view showing one of the retaining loops securing a leg of a waterfowl;

FIG. 6 is a magnified view of the retaining loop in tightened condition; and

FIG. 7 is a front view of a timber strap utilizing a section of coated wire.

### DETAILED DESCRIPTION

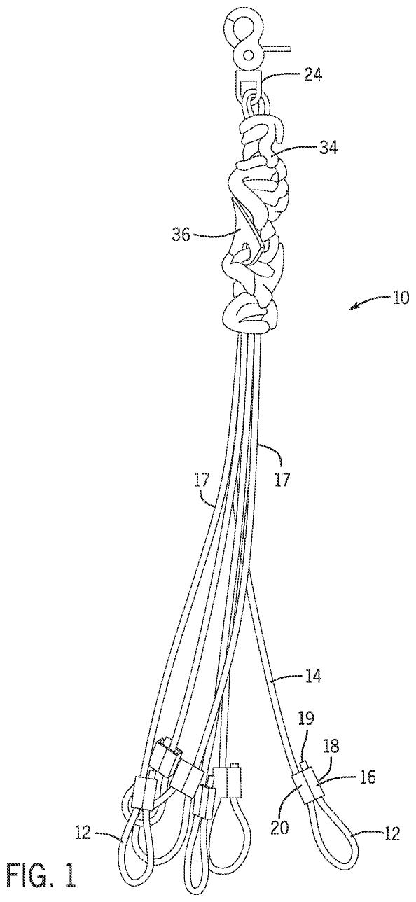

FIG. 1 illustrates the wild game tote 10 constructed in accordance with one exemplary embodiment of the present disclosure. The wild game tote 10 shown in FIG. 1 is designed to allow a hunter to carry multiple small animals or birds after the animals or birds have been shot. In the embodiment shown in FIG. 1, the wild game tote 10 includes six retaining loops 12 that are each adjustable in size and are each designed to hold a leg of the animal or bird that has been shot. It should be understood that the wild game tote 10 could have fewer or a greater number of retaining loops 12 while operating within the scope of the present disclosure.

In the embodiment shown in FIG. 1, the wild game tote 10 includes a plurality of game straps 17 that are each designed to carry one small animal or bird. Each of the game straps 17 includes one of the retaining loops 12. The game straps 17 are each formed from a coated wire section 14 that is used to create one of the retaining loops 12. The wire section 14 is preferably formed from a loop of a braided wire or cable that includes an outer coating, such as decoy wire. The outermost portion of each of the coated wire sections 14 includes a slide block 18 that is used to create and adjust the size of the retaining loop 12 formed on the outer end of the game strap 17. The coated wire sections 14 form the retaining loops 12 by having a first end 19 of the wire section pass through a sliding section 20. The wire section forms the retaining loop 12 and the first end 19 of the wire section is secured within the crimping section 16 of the slide block 18. The wire section 14 can be secured within the crimping section 16 by various different mechanical means, such as by physically crimping the crimping section 16 to reduce the size of the internal passageway in the crimping section 16. After this process, the first end of the wire section 14 will not be able to move relative to the slide block 18.

As can be understood in FIG. 1, the wire section 14 passes through the sliding section 20 of the slide block 18. The outside diameter of the wire section 14 and the inside diameter of the sliding section 20 are selected such that the friction between the outer surface of the wire section 14 and the inner surface of the sliding section 20 create enough of a frictional contact to hold the slide block 18 in a desired position while also allowing the wire section 14 to slide into and out of the sliding section 20 to adjust the size of the retaining loop 12. In the embodiment illustrated, the sliding block 18 is formed from a metal material that can be coated with a material to prevent rusting. In addition, the metal material is selected such that it can be crimped to securely hold the first end 19 of the wire section 14 as shown in FIG. 1.

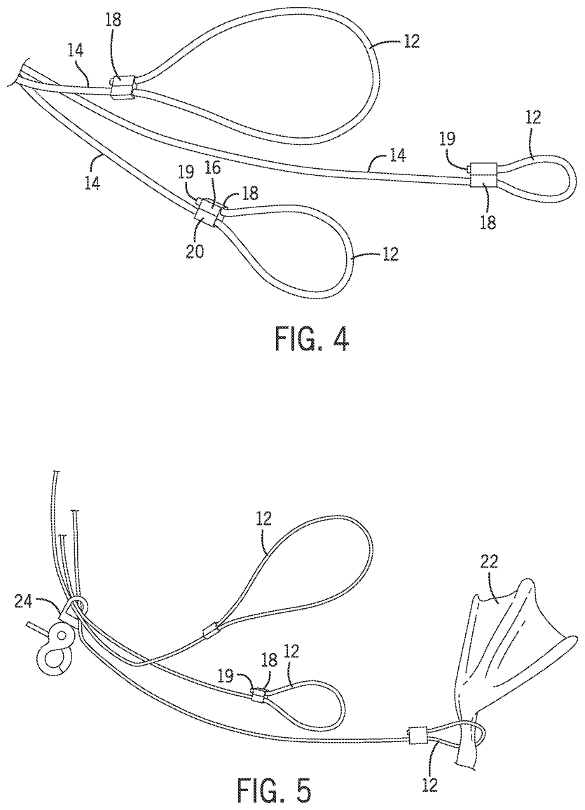

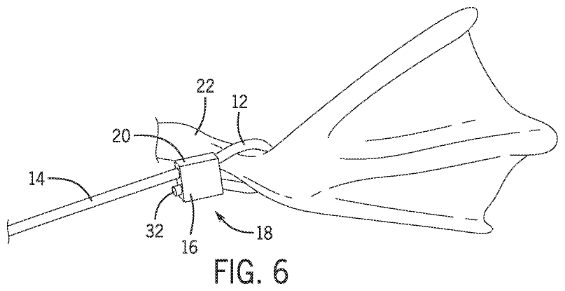

FIG. 4 is a view showing the movement of the slide blocks 18 into different locations along the length of the wire section 14 to adjust the size of the retaining loop 12. It is contemplated that the retaining loop 12 would be expanded in size when initially placing the leg or neck of a small animal or bird within the retaining loop. Once the small animal or bird is positioned withing the retaining loop 12, the wire section 14 is pulled through the sliding section 20 to reduce the size of the retaining loop 12. Since the first end 19 is fixed within the crimping section 16, the retaining loop 12 can be cinched as most clearly shown in FIGS. 5 and 6. In the images shown in FIGS. 5 and 6, a simulated leg 22 of a bird used to show the cinching of the retaining loop 12 to hold the leg 22 of the bird in place.

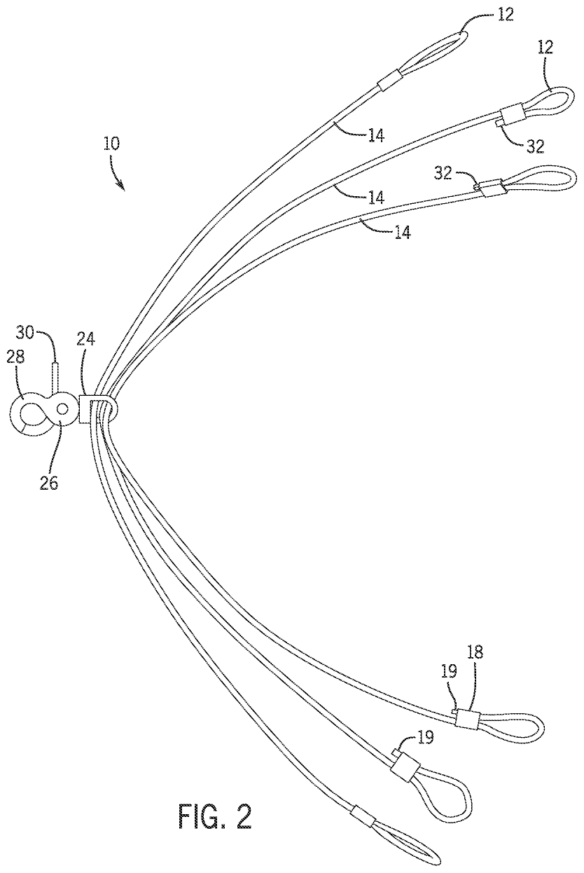

As discussed above, the wild game tote 10 includes six game straps 17 that each include one of the retaining loops 12. In one exemplary embodiment of the present disclosure, the six game straps 17 are formed from three wire sections 14 such that each of the wire sections 14 defines two of the six game straps 17. As shown in the embodiment of FIG. 2, each of the wire sections 14 is a continuous length of coated wire that extends from the first end 19 to a second end 32. Each of the two ends of the continuous length of the coated wire forms a retaining loop 12 by passing through one of the slide blocks 18. In this manner, the three sections of wire can form six game straps 17, each having one of the retaining loops 12. In the embodiment shown, each of the wire sections 14 is formed from a braided steel wire cable that is coated with a plastic, rubber or PVC material. The coating applied to the braided steel wire cable combines to form the wire section 14. The wire section 14 has an outer diameter that is defined by the diameter of the braided steel wire cable and the thickness of the outer coating applied to the wire cable.

As shown in FIG. 2, each of the wire sections 14 passes through a ring 24 that is formed as part of an attachment clip 26. In the embodiment shown, the attachment clip 26 further includes an attachment hook 28 that includes a release lever 30. The release lever 30 allows the entire attachment clip 26 to be securely attached and removed at a desired location by the hunter.

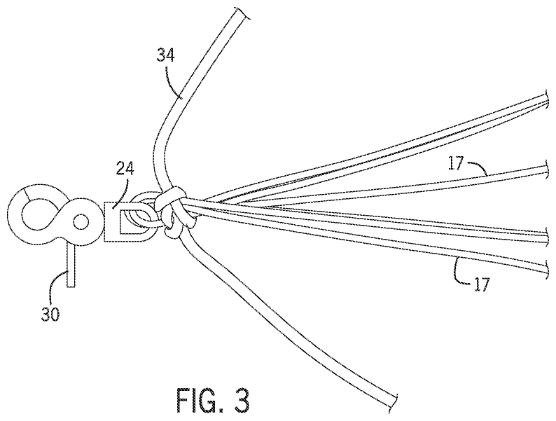

The ring 24 is preferably positioned at the midpoint of the wire section 14 between the first end 19 and the second end 32. Once the ring 24 is located as shown in FIG. 2, a cord 34 can be used to secure the wire sections 14 as shown in FIG. 3. The cord 34 prevents the wire sections 14 from sliding through the ring 24. Once the wire sections 14 are secured as shown, each of the wire sections 14 create two of the game straps 17. In this manner, three wire sections 14 create six game straps 17.

As discussed above, the first and second ends 19, 32 of each of the wire sections 14 are received and securely held within the crimping section 16 of the slide block 18. The configuration of the slide block 18 is most clearly shown in FIG. 6. As shown, the second end 32 of one of the wire section 14 is securely held within the crimping section 16 while the remaining portion of the wire section 14 passes through the sliding section 20. In this manner, the wire section 14 can slide through the sliding section 20 to adjust the size of the retaining loop 12.

Referring now to FIGS. 2 and 3, once all of the wire sections 14 are installed within the ring 24, the cord 34 is used to secure the wire sections to the ring 24. As shown in FIG. 1, the cord 34 holds each of the two halves of the wire sections 14 next to each other and create a loop in the wire section that is attached to the attachment ring 24. In the embodiment shown, the cord 34 includes a leather strip 36 that can be used to display informational or advertising information, such as a brand name or product name for the wild game tote 10.

Although the exemplary embodiment illustrated includes three wire sections 14 that create the six game straps 17, it should be understood that in another contemplated embodiment, each wire section 14 would only be half as long and each wire section 14 would form a single game strap 17. In such an embodiment, a second end of the wire section 14 would be directly connected to the attachment ring 24 instead of passing though the attachment ring 24 as in the embodiment shown. In such as embodiment, the second end of each wire section 14 can include an attachment loop or another type of attachment mechanism for attaching the wire section 14 directly to the ring 24. The opposite first end 19 of such wire sections 14 would create the retaining loop 12 and the same number of retaining loops 12 could be included in the game tote 10.

In the embodiment shown, each of the wire sections 14 is formed from a metal wire or braided cable that includes a coating formed from a vinyl or PVC material. The coating applied to the metal wire or braided cable provides not only protection for the encased wire but also creates an outer surface that increases the sliding friction as compared to a plain section of wire. The outer coating of the wire section can be engaged by the inner surface of the sliding section 20 of the slide block 18 to restrict the sliding movement of the wire section 14 into and out of the slide block 18. Although a vinyl or PVC coated wire is shown and described as being the wire section 14, it is contemplated that other wires or braided ropes could be utilized while operating within the scope of the present disclosure.

During use of the wild game tote 10 of the present disclosure, the hunter would initially have the wild game tote 10 in the condition shown in FIG. 1. When a bird or other animal is shot, the hunter would then expand one of the retaining loops 12 to a desired size, such as shown in FIG. 4. If the game has a small leg or neck, the retaining loop 12 would only need to be expanded to a size slightly larger than the size of the leg. Once the leg is inserted, such as shown in FIG. 5, the slide block 18 is slid back toward the game leg to cinch the game leg as shown in FIG. 6. Once in this position, the wild game tote 10 can be attached back onto the hunter utilizing the attachment clip 26. As shown in FIG. 1, the wild game tote 10 includes six retaining loops 12. However, it is contemplated that fewer or greater numbers of retaining loops could be utilized while operating within the scope of the present disclosure.

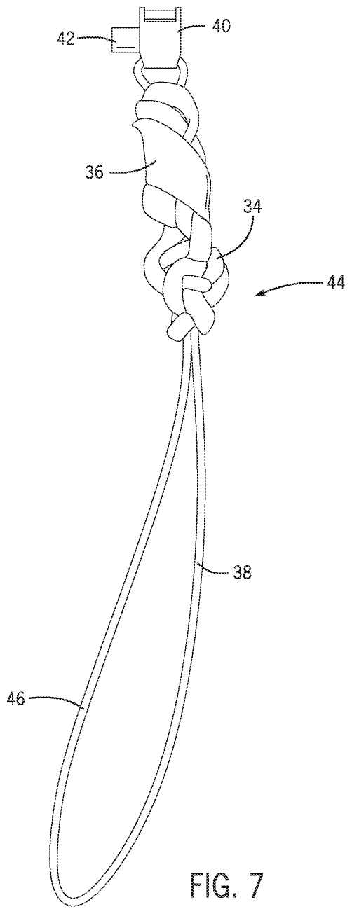

FIG. 7 illustrates another contemplated use of a wire section 38 that is formed from a vinyl or PVC coated wire. The wire section 38 shown in FIG. 7 is attached to an attachment block 40. The attachment block 40 includes a gun attachment element 42 that can be used by the hunter to attach the entire gun loop 44 to the rifle or shot gun. Once attached, the gun loop 44 allows the hunter to exert their arm into the attachment loop 46 and provides a convenient way to carry a gun such as when climbing a tree or into a stand. As in the previous embodiment, a cord 34 having a leather strip 36 is used to secure the wire section 38 in the position shown.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. A game tote for securing a plurality of small animals or birds, the game tote comprising:
a plurality of game straps each being formed from a wire section having a coating, each of the plurality of wire sections having at least a first end;
a retaining loop formed by the wire section on the first end of each of the wire sections of the plurality of game straps; and
a slide block included on the first end of each of the plurality of wire sections, wherein the slide block is movable along the wire section to adjust the size of the retaining loop.

2. The game tote of claim 1 wherein the wire sections are formed from a braided wire.

3. The game tote of claim 2 wherein the coating is vinyl.

4. The game tote of claim 2 wherein the coating is PVC.

5. The game tote of claim 1 wherein each of the game straps is secured to a retaining ring such that each of the plurality of game straps extend from the retaining ring.

6. The game tote of claim 5 wherein a second end of each of the wire sections is secured to the retaining ring.

7. The game tote of claim 5 wherein the retaining ring is coupled to an attachment hook.

8. The game tote of claim 1 wherein each of the slide blocks includes a sliding section and a crimping section, wherein the wire sections are each movable within the sliding section and the first end of the wire section is secured within the crimping section.

9. The game tote of claim 7 wherein an outer diameter of the wire section and the coating is selected such that the wire section frictionally engages an inner diameter of the sliding section such that the frictional engagement restricts the movement of the wire section into and out of the sliding section.

10. A game tote for securing a plurality of small animals or birds, the game tote comprising:
a plurality of game straps each being formed from a wire section having a coating, each of the wire sections having a first end and a second end;
a retaining loop formed by each of the plurality of wire section on each of the first and second ends of the wire sections; and
a slide block included on each of the first and second ends of the plurality of wire sections, wherein the slide block is movable along the wire section to adjust the size of the retaining loop.

11. The game tote of claim 10 wherein each of the wire sections is formed from a braided wire.

12. The game tote of claim 11 wherein the coating is vinyl.

13. The game tote of claim 11 wherein the coating is PVC.

14. The game tote of claim 10 wherein each of the game straps is secured to a retaining ring such that the plurality of game straps extends from the retaining ring.

15. The game tote of claim 14 wherein the retaining ring is coupled to an attachment hook.

16. The game tote of claim 14 wherein each of the wire sections passes through the retaining ring and the wire section is secured to the retaining ring at a location between the first and second ends of the wire section.

17. The game tote of claim 10 wherein each of the slide blocks includes a sliding section and a crimping section, wherein the wire section is movable within the sliding section and the first and second ends of the wire sections are each secured within the crimping section of one of the slide blocks.

18. The game tote of claim 17 wherein an outer diameter of each of the wire sections and the respective coating is selected to frictionally engage an inner diameter of the sliding section such that the frictional engagement restricts the movement of the wire section into and out of the sliding section.
